(19) United States
(12) Patent Application Publication
(10) Pub. No.: US 2020/0369484 A1
(43) Pub. Date: Nov. 26, 2020

(54) CONVEYANCE APPARATUS

(71) Applicant: Konica Minolta, Inc., Tokyo (JP)

(72) Inventors: Yasuhiro SUZUKI, Toyokawa-shi (JP); Masanobu TOMIYASU, Toyokawa-shi (JP); Junichi TANIMOTO, Toyokawa-shi (JP)

(21) Appl. No.: 16/856,471

(22) Filed: Apr. 23, 2020

(30) Foreign Application Priority Data
May 22, 2019 (JP) 2019-096048

(51) Int. Cl. B65H 9/06; B65H 5/06; G03G 15/00

(52) U.S. Cl. CPC B65H 9/06; G03G 15/6529; B65H 5/062

(57) ABSTRACT

A conveyance apparatus that conveys a sheet by passing the sheet through a nip formed between a first conveyance roller and a second conveyance roller contacting each other. The conveyance apparatus includes a first gate member, a second gate member, and a third gate member into which a rotational shaft of the first conveyance roller is loosely inserted, the first and second gate members being disposed at a predefined interval, the third gate member being disposed between the first and second gate members. The first, second, and third gate members each include a portion protruding radially outwards, and the protruding portions are positioned on a conveyance path during no sheet conveyance, the protruding portion of the third gate member being positioned upstream of the protruding portions of the first and second gate members in a conveyance direction.

This application claims priority to Japanese Patent Application No. 2019-096048, filed May 22, 2019, the contents of which are hereby incorporated herein by reference in their entirety.

### BACKGROUND

### Technological Field

The present disclosure relates to a conveyance apparatus that conveys sheets, and particularly to improvement of technique of correcting skew of sheets.

### Description of the Related Art

Recent image forming devices which have increasingly many functions include various processing sections such as printing, imaging, sorting, binding and folding. In order to operate these processing sections appropriately, sheets need to be conveyed straight to each element of the processing sections.

Functions for keeping sheets straight during conveyance include skew correction. Skew correction indicates correcting skew of the leading edge of a sheet relative to a conveyance direction. Known methods for skew correction include a roller resistance method according to which sheet conveyance is suspended during skew correction and a gate resistance method according to which sheet conveyance is not suspended during skew correction. The gate resistance method corrects skew by using a gate disposed on a conveyance path. The gate of the gate resistance method includes movable gate members having protruding portions with a capability of returning to their original positions. A sheet being conveyed pushes the protruding portions of the gate members out of the conveyance path to a retracted position. After the sheet has passed through, the protruding portions of the gate members return onto the conveyance path.

The gate members are arranged in a sheet width direction, and their protruding portions protrude onto the conveyance path owing to a force applied by a torsion spring or the like. When a skew sheet is conveyed, any part of the leading edge of the sheet collides with the protruding portion of one of the gate members and the protruding portion accordingly starts moving to the retracted position against the force of the spring. Upon receiving a conveyance resistance from the protruding portion of the gate member, the part of the leading edge of the sheet, which has collided with the protruding portion, is conveyed at a decreased conveyance speed and thus at a conveyance speed lower than those of other parts of the leading edge which have not collided with the protruding portion. Owing to the difference in conveyance speed among the parts of the leading edge of the sheet, the other parts of the leading edge, which have not collided with the protruding portion, gradually catch up with the part of the leading edge, which has collided with protruding portion. In this way, the skew of the sheet is gradually corrected.

After correction of the skew, the leading edge of the sheet collides with the protruding portions of all the gate members thereby to push all the protruding portions out of the conveyance path to advance. After the sheet has passed through, the protruding portions of the gate members return to their original protruding states by a force of an elastic member. According to skew correction employing the gate resistance method, a pair of gate members is disposed such that the gate members are positioned on the both sides in a sheet width direction of a large sheet being conveyed. Large sheets indicate sheets of a predefined size or larger such as A4 portrait sheets. In fact, small sheets may be conveyed as well as the large sheets as above. Small sheets indicate sheets of a size with a width smaller than that of the large sheets, such as B5 sheets, A5 sheets, postcards, and envelopes.

To correct skew of such small sheets, conventional conveyance apparatuses include a pair of gate members disposed on the center in the sheet width direction, in addition to the above pair of gate members with which both ends of the leading edge of a large sheet collide. Such conventional apparatuses, which include gate members for small sheet skew correction as well as gate members for large sheet skew correction, are disclosed in Japanese Unexamined Patent Application Publication No. 2004-26343. According to the conveyance apparatuses disclosed in Japanese Unexamined Patent Application Publication No. 2004-26343, skew of small sheets is corrected, by using gate members whose protruding portions are disposed on the same positions as protruding portions of gate members for large sheet skew correction in the conveyance direction, or by using gate members whose protruding portions are disposed downstream of protruding portions of gate members for large sheet skew correction in the conveyance direction.

### SUMMARY

By the way, in correction of skew of large sheets, collision noises become louder as the conveyance speed increases. Conventional gate members for skew correction each include protruding portions arranged straight in the sheet width direction and protruding onto the conveyance path. The protruding portions are forced by a torsion spring or the like. Accordingly, in the case where a sheet with no skew is conveyed, the leading edge of the sheet collides with all the protruding portions at the same time to generate a loud collision noise. As the conveyance speed of large sheets increases, the collision noise becomes louder and this is harsh on the ears of users.

Also, small sheets tend to have a higher skew ratio than large sheets. Accordingly, conventional gate members cannot completely correct skew of small sheets. The skew ratio is calculated by dividing a sheet skew amount by a sheet width. As shown in FIG. 1, a large sheet S12 and a small sheet S11 are skew to the same degree by a skew amount T1 in a sheet width direction perpendicular to a conveyance direction. However, the small sheet S1 has a higher skew ratio than the large sheet S12 (T1/W1>T1/W2) according to the above formula because the small sheet S11 has a smaller sheet width, which is the denominator of the skew ratio, than the large sheet S12 (W1<W2).

Despite such a disadvantageous small sheet width, conventional conveyance apparatuses try to correct skew of small sheets, by using gate members whose protruding portions are disposed on the same positions as protruding portions of gate members for large sheet skew correction in the conveyance direction, or by using gate members whose protruding portions are disposed downstream of protruding portions of gate members for large sheet skew correction in the conveyance direction. Unfortunately, the skew of the small sheets cannot be corrected sufficiently.

The present disclosure aims to provide a conveyance apparatus that includes gate members which include protruding portions with which large sheets collide with a lower noise and corrects skew of small sheets with a higher precision.

To achieve the abovementioned objects, the conveyance apparatus reflecting one aspect of the present invention is a conveyance apparatus that conveys a sheet by passing the sheet through a nip formed between a first conveyance roller and a second conveyance roller contacting each other, the conveyance apparatus comprising a first gate member, a second gate member, and a third gate member into which a rotational shaft of the first conveyance roller is loosely inserted, the first and second gate members being disposed at a predefined interval, the third gate member being disposed between the first and second gate members. The first, second, and third gate members each include a portion protruding radially outwards, and the protruding portions are positioned on a conveyance path during no sheet conveyance, the protruding portion of the third gate member being positioned upstream of the protruding portions of the first and second gate members in a conveyance direction. When a first sheet having a width equal to the predefined interval or larger is conveyed, the protruding portions of the first, second, and third gate members push back a leading edge of the first sheet, and then move away from the conveyance path. When a second sheet having a width smaller than the predefined interval is conveyed, only the protruding portion of the third gate member pushes back a leading edge of the second sheet, and then moves away from the conveyance path.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the invention. In the drawings:

FIG. 1 shows a large sheet S12 and a small sheets S11 which are skew to the same degree;

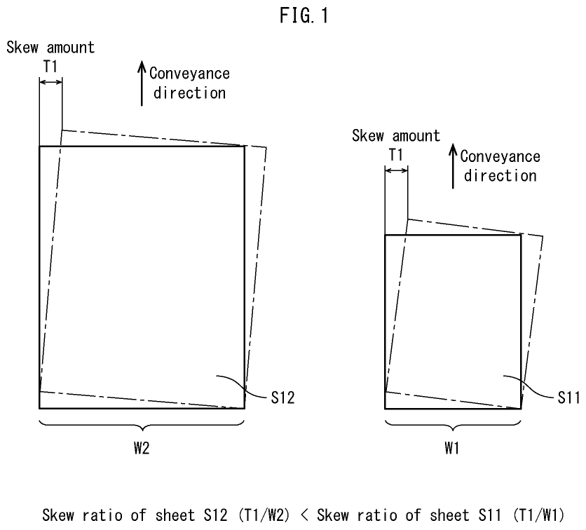

FIG. 2 shows the overall structure of a printer relating to an embodiment of the present disclosure;

FIG. 3 is a perspective view of the structure of a timing roller pair and a gate;

FIG. 4 is an exploded perspective view seen from a direction indicated by an arrow E in FIG. 3 from which a second timing roller 52 is removed;

FIG. 5 is a plan view seen from a direction indicated by an arrow F in FIG. 3 from which the second timing roller 52 is removed;

FIG. 6 shows the side of a first timing roller 51 to which a paper feed guide 411 separates off a conveyance path 38 in FIG. 2;

FIG. 7A to FIG. 7C are cross-sectional views, cut along a line I-I in FIG. 3;

FIG. 8A to FIG. 8C show the process of skew correction of a small sheet S1;

FIG. 9A to FIG. 9C are cross-sectional views, cut along the line I-I in FIG. 3;

FIG. 10A to FIG. 10C show the process of feeding of a large sheet S2 with no skew;

FIG. 11 shows movable gate members 630 and 640 forced by separate springs;

FIG. 12A shows a torsion spring 626 having a high number of turns and accordingly a high restoring force, and FIG. 12B shows a compression spring 619 which couple mounting plates 615 and 617 to each other;

FIG. 13A to FIG. 13C are cross-sectional views, cut along the line I-I in FIG. 3; and

FIG. 14 shows the structure of a conveyance apparatus including only one movable gate member for correcting skew of small sheets.

### DETAILED DESCRIPTION OF EMBODIMENTS

Hereinafter, one or more embodiments of the present disclosure will be described with reference to the drawings. However, the scope of the invention is not limited to the disclosed embodiments.

The following describes an embodiment of an image forming device including a conveyance apparatus relating to the present disclosure with use of an example of a tandem-type color printer (hereinafter, referred to simply as printer).

[1] Overall Structure

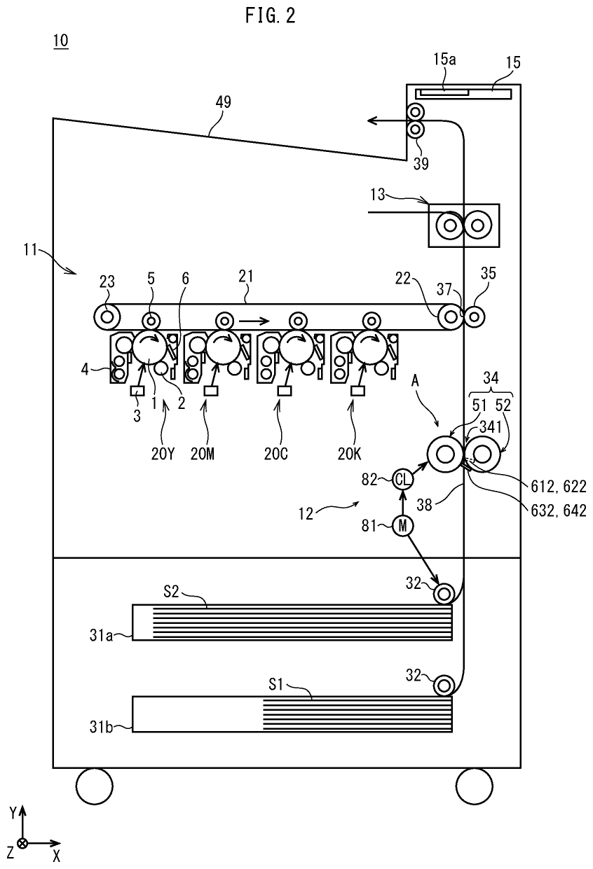

FIG. 2 shows the overall structure of a printer 10. In the figure, a lateral direction and a vertical direction when the printer 10 is viewed from the front are respectively defined as an X-axis direction and a Y-axis direction. Also, a direction perpendicular to both the X-axis direction and the Y-axis direction is defined as a Z-axis direction. As shown in the figure, the printer 10 includes an image forming unit 11, a conveyance unit 12, a fixing unit 13, and paper cassettes 31a and 31b. The printer 10 is connected to a network such as a LAN to execute print jobs in accordance with print job execution instructions issued by an external terminal which is not illustrated. Among the elements constituting the printer 10, the conveyance unit 12 serves as a conveyance apparatus.

(1-1) Image Forming Unit 11

The image forming unit 11 includes image forming subunits 20Y, 20M, 20C, and 20K which respectively correspond to yellow (Y), magenta (M), cyan (C), and black (K) colors, an intermediate transfer belt 21, and so on.

The image forming subunits 20Y, 20M, 20C, and 20K are disposed in series at regular intervals along the intermediate transfer belt 21. The image forming subunit 20Y forms a yellow toner image on a photoconductive drum 1 included therein. The image forming subunit 20Y also includes a charger 2, an exposure unit 3, a developing unit 4, a primary transfer roller 5, a cleaner 6, and so on, which are disposed around the photoconductive drum 1. The primary transfer roller 5 faces the photoconductive drum 1 with the intermediate transfer belt 21 therebetween. The cleaner 6 is for cleaning the surface of the photoconductive drum 1. The exposure unit 3 functions as an image writing unit, and specifically emits optical beams from a large number of LEDs arranged in rows in a main scanning direction to scan the surface of the photoconductive drum 1 in the main scanning direction, which corresponds to the Z-axis direction. The image forming subunits 20M, 20C, and 20K have basically the same structure as the image forming subunit 20Y, and form toner images of the respective colors. In the figure, numerical references for the elements constituting the image forming subunits 20M, 20C, and 20K are omitted.

The intermediate transfer belt 21 is an endless belt, and rotates to run in a direction indicated by an arrow in the figure while being tensioned by a driving roller 22 and a driven roller 23.

(1-2) Conveyance Unit 12

The conveyance unit 12 includes pickup rollers 32, a timing roller pair 34, and a secondary transfer roller 35 which is brought into pressure-contact with the driving roller 22 via the intermediate transfer belt 21. The conveyance unit 12 picks up large sheets S2 and small sheets S1 from the paper cassettes 31a, 31b, or a manual feed tray which is not illustrated. In the present embodiment, large sheets S2 are portrait sheets with the width of A4 size sheets or larger, and small sheets S1 are portrait sheets with a width of smaller than the width of A4 size sheets. Also, the large sheets S2 and the small sheets S1 include standard size sheets housed in the paper cassettes 31a and 31b, such as A3-size through A7-size sheets, B4-size through B7-size sheets, post cards, and envelopes, and also include non-standard size sheets housed in the manual feed tray which is not illustrated.

(1-3) Fixing Unit 13

The fixing unit 13 forms a fixing nip by bringing a fixing roller and a pressure roller into pressure-contact with each other, and also maintains a necessary fixing temperature such as 180 degrees C. by heating the fixing roller with a heater.

[2] Timing Roller Pair 34

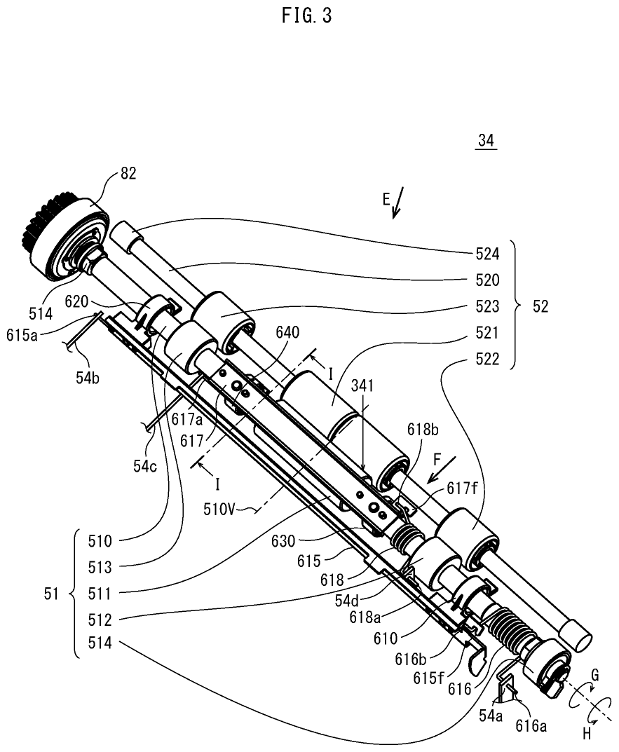

FIG. 3 is a perspective view of the structure of the timing roller pair 34 when viewed in a direction indicated by an arrow A in FIG. 2. As shown in FIG. 3, the timing roller pair 34 includes a first timing roller 51 and a second timing roller 52. Specifically, the first timing roller 51 includes a rotational shaft 510, roller bodies 511, 512, and 513, and a bearing 514. The second timing roller 52 includes a rotational shaft 520, roller bodies 521, 522, and 523, and a bearing 524. The second timing roller 52 is forced toward a direction indicated by an arrow F by a compression coil spring which is not illustrated, such that the roller bodies 521, 522, and 523 of the second timing roller 52 are respectively pressed against the roller bodies 511, 512, and 513 of the first timing roller 51. The roller bodies of the first timing roller 51 and the roller bodies of the second timing roller 52, which correspond one-to-one to each other, form a nip 341 at each of contact portions therebetween. The timing roller pair 34 catches, into the nip 341, a large sheet S2 or a small sheet S1 picked up by the pickup rollers 32.

The first timing roller 51 rotates upon receiving a rotation driving force from a drive motor 81 via an electromagnetic clutch 82 as shown in FIG. 2. When the intermediate transfer belt 21 rotates to move toner images layered thereon toward a secondary transfer position 37, the timing roller pair 34 starts to rotate upon receiving the rotation driving force of the drive motor 81 via the electromagnetic clutch 82. This sends the large sheet S2 or the small sheet S1, which is caught into the nip 341, toward the secondary transfer position 37.

[3] Structure of Skew Correction Unit

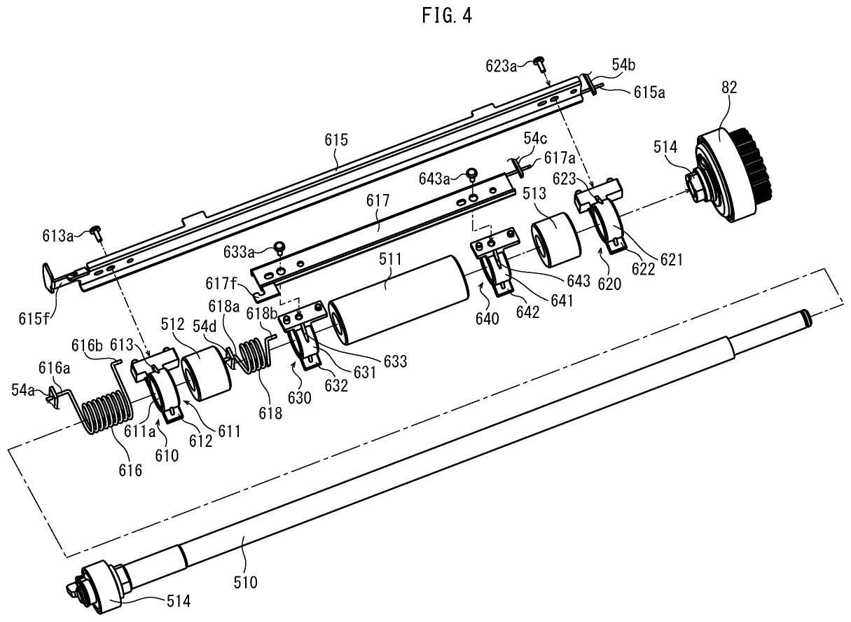

The following describes a skew correction unit with reference to FIG. 3 and FIG. 4. FIG. 4 is an exploded perspective view seen from a direction indicated by an arrow E in FIG. 3 from which the second timing roller 52 is removed.

As shown in FIG. 4, the rotational shaft 510 of the first timing roller 51 is loosely inserted into a pair of movable gate members 610 and 620. The pair of movable gate members 610 and 620 is mounted to a mounting plate 615 and is forced by a torsion spring 616. Also, the rotational shaft 510 of the first timing roller 51 is loosely inserted into a pair of movable gate members 630 and 640 between the movable gate members 610 and 620. The pair of movable gate members 630 and 640 is mounted to a mounting plate 617 and is forced by a torsion spring 618. In this way, the skew correction unit includes the mounting plate 615, the torsion spring 616, the movable gate members 610 and 620, and also includes the mounting plate 617, the torsion spring 618, and the movable gate members 630, and 640.

(3-1) Movable Gate Member 610

The movable gate member 610 is a gate member of the gate resistance method. As shown in FIG. 4, the movable gate member 610 includes a circular portion 611, a protruding portion 612, and an arm portion 613. The protruding portion 612 is a claw-shaped portion protruding radially outwards from the outer circumferential surface of the circular portion 611. The arm portion 613 protrudes from the outer circumferential surface of the circular portion 611 on the opposite side to the protruding portion 612. The movable gate member 610 further includes a circular rib which is not illustrated. The circular rib extends from the inner circumferential surface of the circular portion 611 toward the center of a through-hole 611a of the circular portion 611. This keeps a small contact area between the circular portion 611 and the outer circumferential surface of the rotational shaft 510 of the first timing roller 51 while bringing the inner circumferential surface of the circular rib into substantially close contact with the outer circumferential surface of the rotational shaft 510. Owing to the small contact area with the rotational shaft 510, the circular portion 611 functions as a slide bearing for the rotational shaft 510 of the first timing roller 51. The protruding portion 612 has a surface with which a sheet is brought into abutment. In accordance with rotation of the movable gate member 610 around the rotational shaft 510 of the first timing roller 51, the protruding portion 612 protrudes onto a conveyance path 38 as shown in FIG. 2 and retracts out of the conveyance path 38. Note that the other movable gate members 620, 630, and 640 have the same structure as the movable gate member 610. Specifically, the movable gate member 620 includes a circular portion 621, a protruding portion 622, and an arm portion 623. The movable gate member 630 includes a circular portion 631, a protruding portion 632, and an arm portion 633. The movable gate member 640 includes a circular portion 641, a protruding portion 642, and an arm portion 643. As shown in FIG. 3, the movable gate members 610 and 620 are symmetrical about a perpendicular line 510V, and the movable gate members 630 and 640 are symmetrical about the perpendicular line 510V. The perpendicular line 510V is perpendicular to the center of the rotational shaft 510 of the first timing roller 51 in an axial direction of the rotational shaft 510.

(3-2) Mounting Plates 615 and 617

The mounting plate 615 is mounted to the arm portions 613 and 623 by screws 613a and 623a, respectively. This enables the mounting plate 615 to hold the movable gate members 610 and 620 in the same orientation to keep the common angle around the rotational shaft 510 to the movable gate members 610 and 620. Similarly, the mounting plate 617 is mounted to the arm portions 633 and 643 by screws 633a and 643a, respectively. This enables the mounting plate 617 to hold the movable gate members 630 and 640 in the same orientation to keep the common angle around the rotational shaft 510 to the movable gate members 630 and 640.

(3-3) Torsion Springs 616 and 618

As shown in FIG. 3, the one end of the rotational shaft 510 is loosely inserted into the torsion spring 616. Ends 616a and 616b of the torsion spring 616 are respectively fixed to a frame 54a of a bottom plate of a housing and a hook 615f of the mounting plate 615. With this structure, when the movable gate members 610 and 620 rotate around the rotational shaft 510 together with the mounting plate 615, the torsion spring 616 expands due to displacement of the mounting plate 615. A restoring force of the torsion spring 616 acts in a direction for rotating the movable gate members 610 and 620 clockwise, namely, in a direction indicated by an arrow G in FIG. 3. When the movable gate members 610 and 620 rotate by the restoring force of the torsion spring 616, one axial end 615a of the mounting plate 615 collides with a frame 54b of a side wall of the housing. This prevents further rotation to stop the movable gate members 610 and 620. The torsion spring 618 has the similar structure to the torsion spring 616. Specifically, the one end of the rotational shaft 510 is loosely inserted into the torsion spring 618. Ends 618a and 618b of the torsion spring 618 are respectively fixed to a frame 54d of the bottom plate of the housing and a hook 617f of the mounting plate 617. When the movable gate members 630 and 640 rotate by the restoring force of the torsion spring 618, one axial end 617a of the mounting plate 617 collides with a frame 54c of the side wall of the housing. This prevents further rotation to stop the movable gate members 630 and 640.

[4] First and Second Protruding Positions on Conveyance Path 38

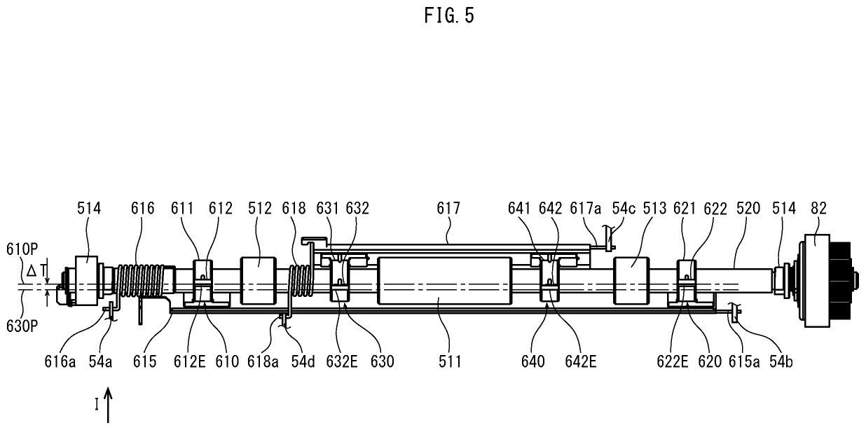

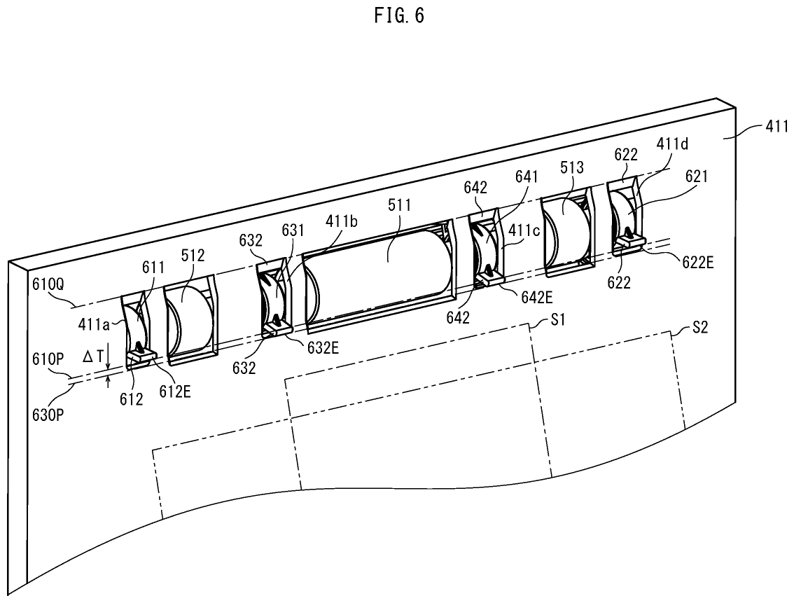

FIG. 5 is a plan view seen from the direction indicated by the arrow F in FIG. 3 from which the second timing roller 52 is removed. FIG. 6 shows the side of the first timing roller 51 to which a paper feed guide 411 separates off the conveyance path 38 shown in FIG. 2.

As shown in FIG. 5, while the axial end 615a of the mounting plate 615 collides with the frame 54b of the side wall of the housing, an end edge 612E of the protruding portion 612 of the movable gate member 610 and an end edge 622E of the protruding portion 622 of the movable gate member 620 are stationary at positions indicated by numerical reference 610P in a conveyance direction of the paper feed guide 411 shown in FIG. 6. The positions, which are indicated by numerical reference 610P, are referred to as first protruding positions. When a large sheet S2 with skew is conveyed upward from the downside in FIG. 6, the movable gate members 610 and 620, which respectively include the protruding portions 612 and 622 at the first protruding positions 610P, start correcting the skew of the large sheet S2.

Also, while the axial end 617a of the mounting plate 617 collides with the frame 54c of the side wall of the housing, an end edge 632E of the protruding portion 632 of the movable gate member 630 and an end edge 642E of the protruding portion 642 of the movable gate member 640 are stationary at positions indicated by numerical reference 630P in the conveyance direction of the paper feed guide 411. The positions, which are indicated by numerical reference 630P, are referred to as second protruding positions. When a small sheet S1 with skew is conveyed upward from the downside in FIG. 6, the movable gate members 630 and 640, which respectively includes the protruding portions 632 and 642 at the second protruding positions 630P, start correcting the skew of the small sheet S1.

The paper feed guide 411 has four through-holes 411a, 411b, 411c, and 411d in the width direction as shown in FIG. 6, as well as respective through-holes for the roller bodies 511, 512, and 513.

While the respective protruding portions 612 and 622 of the movable gate members 610 and 620 are set to the first protruding positions 610P, the protruding portions 612 and 622 respectively protrude from the through-holes 411a and 411d onto a surface of the paper feed guide 411. Similarly, while the respective protruding portions 632 and 642 of the movable gate members 630 and 640 are set to the second protruding positions 630P, the protruding portions 632 and 642 respectively protrude from the through-holes 411b and 411c onto the surface of the paper feed guide 411. With this structure, a small sheet S1 which is conveyed upward from the downside (Y-axis direction) in FIG. 6 collides with the protruding portions 632 and 642. Also, a large sheet S2 which is conveyed similarly collides with the protruding portions 612, 622, 632, and 642.

When the leading edge of the small sheet S1 or the large sheet S2 collides with any one or more of the protruding portions 612, 622, 632, and 642, any corresponding one or more of the movable gate members 610, 620, 630, and 640 rotate around the rotational shaft 510 and the any protruding portions accordingly fit into any corresponding one or more of the through-holes 411a, 411d, 411b, and 411c. Thus, any corresponding one or more of the end edges 612E, 622E, 632E, and 642E of the any protruding portions retract to positions 610Q in FIG. 6. The positions 610Q are retracted positions of the protruding portions 612, 622, 632, and 642 of the movable gate members 610, 620, 630, and 640. The retracted positions are common to the movable gate members 610, 620, 630, and 640. Meanwhile, the second protruding positions 630P are positioned in front of (upstream of) the first protruding positions 610P in the conveyance direction by a distance ΔT. By providing the second protruding positions 630P of the protruding portions 632 and 642 in front of the first protruding positions 610P of the protruding portions 612 and 622 in the conveyance direction in this manner, it is possible to increase a time period until the protruding portions 632 and 642 respectively fit into the through-holes 411b and 411c.

The protruding portions 632 and 642 of the movable gate members 630 and 640 are positioned upstream of the protruding portions 612 and 622 of the movable gate members 610 and 620 in the conveyance direction of large sheets S2. With this structure, if the restoring force of the torsion spring 618 is too high, a large sheet S2 which has collided with the protruding portions 632 and 642 is pushed back by the movable gate members 630 and 640, which are forced by the torsion spring 618, and thus does not collide with the movable gate members 610 and 620, which are positioned on the outer sides in a shaft direction of the rotational shaft 510. In view of this, the number of turns of the torsion spring 618, which forces the movable gate members 630 and 640 positioned on the inner sides in the shaft direction, is set to be smaller than the number of turns of the torsion spring 616, which forces the movable gate members 610 and 620 positioned on the outer sides in the shaft direction. Also, a force of the torsion spring 618 for pushing back the large sheet S2 is set to be smaller than that of the torsion spring 616. Owing to these settings, the large sheet S2 collides with all the protruding portions 612, 622, 632, and 642.

[5] Skew Correction of Small Sheet S1

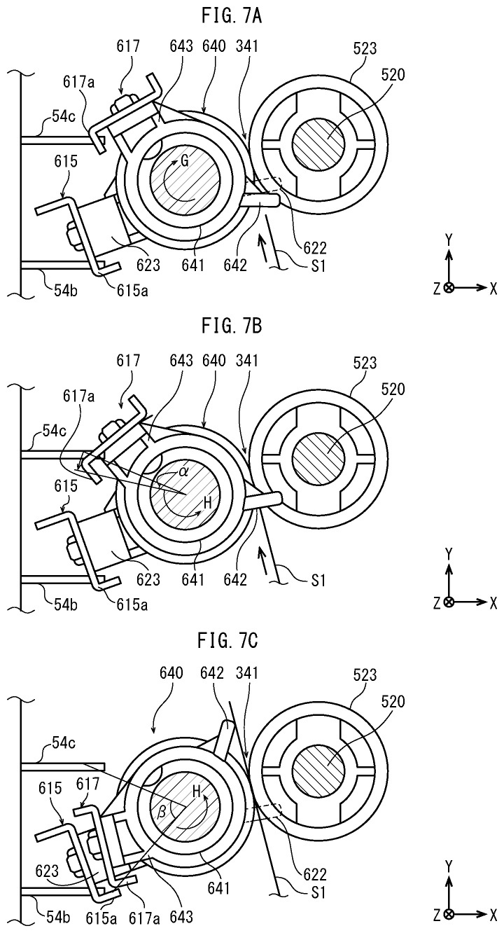

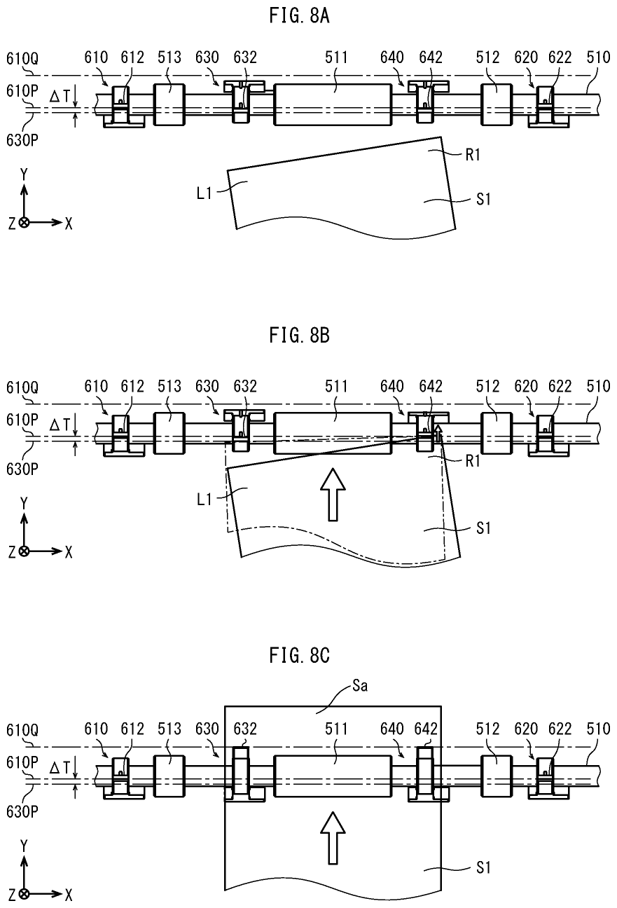

The following describes the operations of the movable gate members 630 and 640 for correcting skew of a small sheet S1, with reference to FIG. 7A to FIG. 7C and FIG. 8A to FIG. 8C. FIG. 7A to FIG. 7C are cross-sectional views, cut along a line I-I in FIG. 3. FIG. 8A to FIG. 8C are schematic plan views of the conveyance path 38 in FIG. 6 seen from the horizontal direction, showing only the rotational shaft 510, the roller bodies 511 to 513, and the movable gate members 610, 620, 630, and 640.

(5-1) Standby Mode

FIG. 7A and FIG. 8A show a state where the movable gate member 640 is in a standby mode and the small sheet S1 is about to enter the nip 341.

In the standby mode in FIG. 7A, the restoring force of the torsion spring 618 acts on the mounting plate 617 to rotate the movable gate members 630 and 640 clockwise, namely, in a direction indicated by an arrow G in the figure. Then, the axial end 617a of the mounting plate 617, to which the movable gate members 630 and 640 are mounted, collides with the frame 54c of the side wall of the housing. This maintains the protruding portions 642 and 632 of the movable gate members 640 and 630 at the second protruding positions 630P as shown in FIG. 8A.

The same applies to the movable gate members 610 and 620. Specifically, the restoring force of the torsion spring 616 acts on the mounting plate 616 to rotate the movable gate members 610 and 620 clockwise. Then, the axial end 615a of the mounting plate 616, to which the movable gate members 610 and 620 are mounted, collides with the frame 54b of the side wall of the housing. This maintains the protruding portions 612 and 622 at the first protruding positions 610P as shown in FIG. 8A.

(5-2) Collision of Small Sheet S1

When the small sheet S1 collides with the protruding portion 642, the axial end 617a of the mounting plate 617, which is forced by the torsion spring 618, rotates by angle α in a direction indicated by an arrow H as shown in FIG. 7B.

Upon colliding with the protruding portion 642, the small sheet S1 receives a conveyance resistance from the movable gate member 640. This generates a difference in conveyance speed between a left edge L1 and a right edge R1 of the small sheet S1 as shown in FIG. 8B. The conveyance speed at the right edge R1 decreases and then the left edge L1 catches up with the right edge R1, such that the small sheet S1 is corrected to be straight and thus turns in the conveyance direction as indicated by dash-dotted lines in FIG. 8B.

(5-3) Passing of Small Sheet S1 through Nip 341

FIG. 7C and FIG. 8C show a state where a leading edge Sa of the small sheet S1 being conveyed passes through the nip 341 of the timing roller pair 34. After the leading edge Sa of the small sheet S1 has passed through the nip 341, the axial end 617a of the mounting plate 617, which is forced by the torsion spring 618, rotates by an angle β (β>α) in the direction H as shown in FIG. 7C. This maximum rotation of the mounting plate 617 causes the protruding portions 632 and 642 to retract to the retracted positions 610Q as shown in FIG. 8C to respectively fit into the through-holes 411b and 411c of the paper feed guide 411 (see FIG. 6).

The movable gate members 630 and 640 largely rotate counterclockwise in the direction H, such that the protruding portions 632 and 642 displace from the second protruding positions 630P, which are the reference, to the retracted positions 610Q, and also the torsion spring 618 largely expands. The restoring force of the torsion spring 618 accordingly increases to a large extent. However, the protruding portions 632 and 642 receive a larger pressing force than the restoring force from the small sheet S1 being conveyed, which has collided with the protruding portions 632 and 642. Thus, the protruding portions 632 and 642 are maintained at the retracted positions 610Q.

When the trailing edge of the small sheet S1 being conveyed passes through the nip 341 of the timing roller pair 34 and then the small sheet S1 leaves the protruding portions 632 and 642, the pressing force of the small sheet S1 does not act on the protruding portions 632 and 642 any longer. Owing to the rotation of the axial end 617a of the mounting plate 617 by the angle β, only the restoring force accumulated in the torsion spring 618 acts on the mounting plate 617. Thus, the movable gate members 630 and 640 rotate clockwise in the direction G such that the protruding portions 632 and 642 return from the retracted positions 610Q toward the second protruding positions 630P. With this rotation, the mounting plate 617 returns to its standby position in a reverse manner, namely, from the position in FIG. 7C to the position in FIG. 7A via the position in FIG. 7B.

[6] Feeding of Large Sheet S2

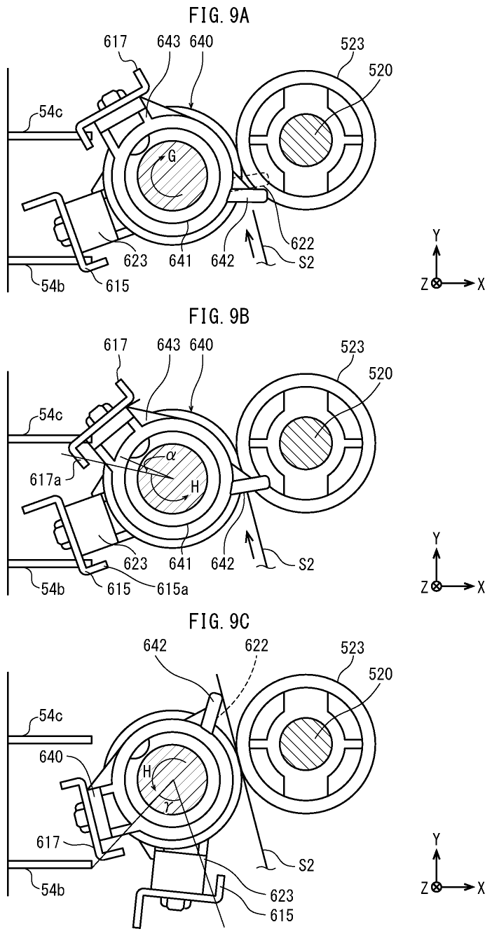

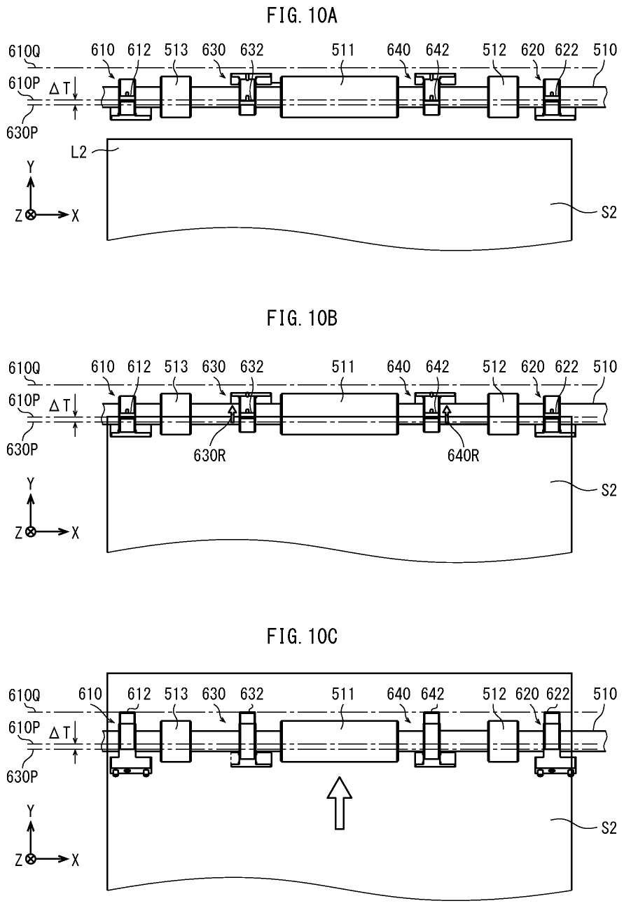

The following describes the operations of the movable gate members 610, 620, 630, and 640 while a large sheet S2 with no skew passes through the first protruding positions 610P and the second protruding positions 630P, with reference to FIG. 9A to FIG. 9C and FIG. 10A to FIG. 10C. FIG. 9A to FIG. 9C show the operations of the movable gate members 640 and 620 while a large sheet S2 passes through, with use of the same description as in FIG. 7A to FIG. 7C. FIG. 10A to FIG. 10C show the operations of the movable gate members 610, 620, 630, and 640 while the large sheet S2 with no skew passes through, with use of the same description as in FIG. 8A to FIG. 8C.

(6-1) Standby Mode

FIG. 9A and FIG. 10A show a state where the movable gate members 610, 620, 630, and 640 are in the standby mode and the large sheet S2 with no skew is about to enter the nip 341. In the similar manner as in FIG. 7A and FIG. 8A, the restoring forces of the torsion springs 616 and 618 respectively act on the mounting plates 615 and 617, and then the protruding portions 612 and 622 are stationary at the first protruding positions 610P and the protruding portions 632 and 642 are stationary at the second protruding positions 630P as shown in FIG. 10A.

(6-2) Collision of Large Sheet S2 with No Skew

The second protruding positions 630P of the protruding portions 632 and 642 of the movable gate members 630 and 640 are upstream of the first protruding positions 610P of the protruding portions 612 and 622 of the movable gate members 610 and 620, as shown in FIG. 6. Accordingly, upon being fed, the large sheet S2 collides with the protruding portions 632 and 642 of the movable gate members 630 and 640 as shown in FIG. 9B. Then, as shown in FIG. 9B, the axial end 617a of the mounting plate 617 rotates by the angle α from the frame 54c of the side wall of the housing in the similar manner as in FIG. 7B. The movable gate members 630 and 640 accordingly rotate such that protruding portions 632 and 642 displace as indicated by arrows 630R and 640R respectively in FIG. 10B.

(6-3) Passing through of Large Sheet S2 with No Skew

After the movable gate members 630 and 640 rotate to retract out of the conveyance path 38, the leading edge of the large sheet S2 with no skew collides with the protruding portions 612 and 622 of the movable gate members 610 and 620, which are positioned on the outer sides in the shaft direction, as shown in FIG. 10B.

Upon receiving a conveyance force from the large sheet S2, the axial end 615a of the mounting plate 615 rotates by an angle γ in the direction H to push the protruding portions 612 and 622 out of the conveyance path 38 as shown in FIG. 9C. The protruding portions 612, 622, 632, and 642 retract to the retracted positions 610Q to respectively fit into the through-holes 411a, 411d, 411b, and 411c of the paper feed guide 411, as shown in FIG. 10C.

When the trailing edge of the large sheet S2 being conveyed passes through the nip 341 of the timing roller pair 12 and then the large sheet S2 leaves the protruding portions 612 and 622, the pressing force of the large sheet S2 does not act on the movable gate members 610 and 620 any longer. Owing to the rotation of the axial end 615a of the mounting plate 615 by the angle γ, a restoring force by the rotation is accumulated in the torsion spring 616. After the large sheet S2 has passed through the nip 341, only the restoring force of the torsion spring 616 acts on the mounting plate 617. Thus, the movable gate members 610 and 620 rotate clockwise in the direction G such that the protruding portions 612 and 622 return from the retracted positions 610Q toward the second protruding positions 630P. With this rotation, the mounting plate 615 returns to its standby position in a reverse manner, namely, from the position in FIG. 9C to the position in FIG. 9A via the position in FIG. 9B.

(6-4) Passing through of Large Sheet S2 with Skew

In the case where a large sheet S2 with skew is conveyed, the leading edge of the large sheet S2 collides with one of the protruding portions 632 and 642, and then movable gate members 630 and 640 accordingly rotate. Next, the leading edge of the large sheet S2 collides with at least one of and then both the protruding portions 612 and 622, and accordingly the movable gate members 610 and 620 rotate.

In the case where a skew amount of the large sheet S2 is small, only the force of the torsion spring 618 corrects the skew of the large sheet S2. Specifically, while the protruding portions 632 and 642 rotate to retract out of the conveyance path 38 due to collision of the leading edge of the large sheet S2 with one of the protruding portions 632 and 642, a conveyance resistance is applied to the leading edge of the large sheet S2 thereby to correct the skew of the large sheet S2.

In the case where the skew amount of the large sheet S2 is not small but large to a certain degree, only the force of the torsion spring 618 cannot correct the skew of the large sheet S2. Specifically, while the protruding portions 632 and 642 rotate to retract out of the conveyance path 38 due to collision of the leading edge of the large sheet S2 with one of the protruding portions 632 and 642, a conveyance resistance is applied to the leading edge of the large sheet S2 to correct only part of the skew of the large sheet S2.

Then, the leading edge of the large sheet S2 still having the skew collides with one of the protruding portions 612 and 622. The one of the protruding portions 612 and 622 presses the leading edge of the large sheet S2 to apply a conveyance resistance to the leading edge, such that the remaining skew of the large sheet S2 is corrected and thus the large sheet S2 is corrected to be straight. As described above, when a large sheet S2 with a large skew is conveyed, skew correction is ensured by two-step operations of: the first step in which the protruding portions 632 and 642 correct part of the skew of the large sheet S2; and the second step in which the protruding portions 612 and 622 correct the remaining skew of the large sheet S2.

[7] Summary of Embodiment

According to the present embodiment as described above, in the case where a large sheet S2 with skew is conveyed, the large sheet S2 collides with the protruding portions 632 and 642 of the movable gate members 630 and 640, which are forced by the torsion spring 618 having a smaller restoring force than the torsion spring 616, before colliding with the protruding portions 612 and 622 of the movable gate members 610 and 620. A momentum of the large sheet S2 by this collision is mainly converted into a momentum of the movable gate members 630 and 640, and thus a noise resulting from the collision is low.

When the large sheet S2 collides with the movable gate members 610 and 620, a remainder of the momentum after loss by the collision with the movable gate members 630 and 640 is converted into a sound energy. A noise resulting from the sound energy is slightly low. This is not harsh on the ears of a user who is around the printer.

Since the protruding portions 632 and 642 of the movable gate members 630 and 640 are provided upstream of the protruding portions 612 and 622 of the movable gate members 610 and 620, a small sheet S1 continues to collide with the protruding portions 632 and 642 for a long time period. Accordingly, sheet skew is corrected by applying a conveyance resistance for a long time period. According to the present embodiment as described above, it is possible to lower noises generated by collision of large sheets with the movable gate members, and also improve the printing quality of small sheets.

[8] Modifications

Above, the present disclosure has been described based on the embodiment, but the present disclosure is of course not limited to the above embodiment and may include the following modifications.

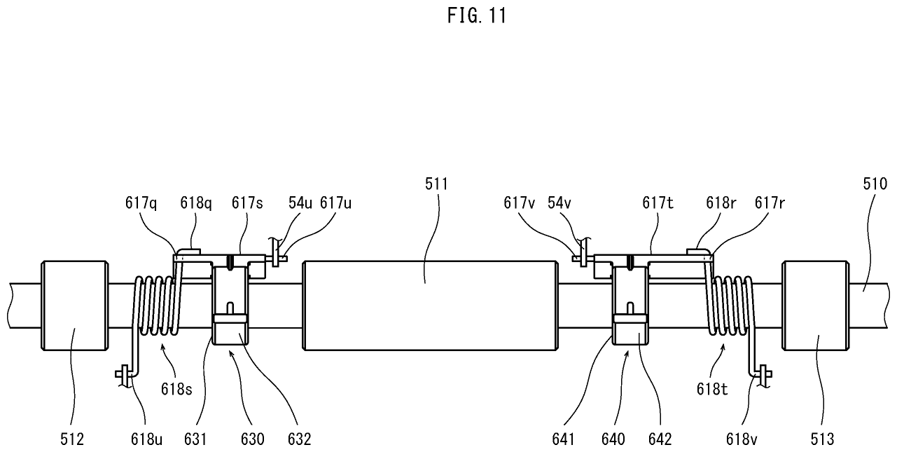

(1) In the above embodiment, the movable gate members 630 and 640 are mounted to the single mounting plate 617. However, the present disclosure is not limited to this. The movable gate members 630 and 640 may be mounted respectively to separate mounting plates 617s and 617t which are respectively forced by separate torsion springs 618s and 618t. Specifically, FIG. 11 shows the movable gate members 630 and 640 which are forced by the separate springs. In FIG. 11, the movable gate members 630 and 640 are mounted respectively to the separate mounting plates 617s and 617t.

One ends 618q and 618r of the respective torsion springs 618s and 618t are respectively fixed to hooks 617q and 617r of the respective mounting plates 617s and 617t. With this structure, the mounting plates 617s and 617t are respectively forced by the torsion springs 618s and 618t. Also, axial ends 617u and 617v of the respective mounting plates 617s and 617t respectively collide with frames 54u and 54v of the side wall of the housing. With this structure, the protruding portions 632 and 642 of the movable gate members 630 and 640, which are respectively mounted to the mounting plates 617s and 617t, stop at the second protruding positions, which are upstream of the first protruding positions for the protruding portions 611 and 612 of the movable gate members 610 and 620, which are mounted to the mounting plate 615. Owing to the movable gate members 630 and 640 being forced by the separate springs, when the leading edge of a small sheet S1 collides with one of the movable gate members 630 and 640, the one movable gate member with which the leading edge has collided rotates and the other movable gate member does not rotate. In this way, only one of the movable gate members 630 and 640, which has collided with the leading edge of the sheet collides, is rotated. Thus, it is possible to increase a difference in conveyance speed between the one movable gate member with which the leading edge of the sheet has collided and the other movable gate member with which the leading edge of the sheet does not collide, thereby to ensure skew sheet correction.

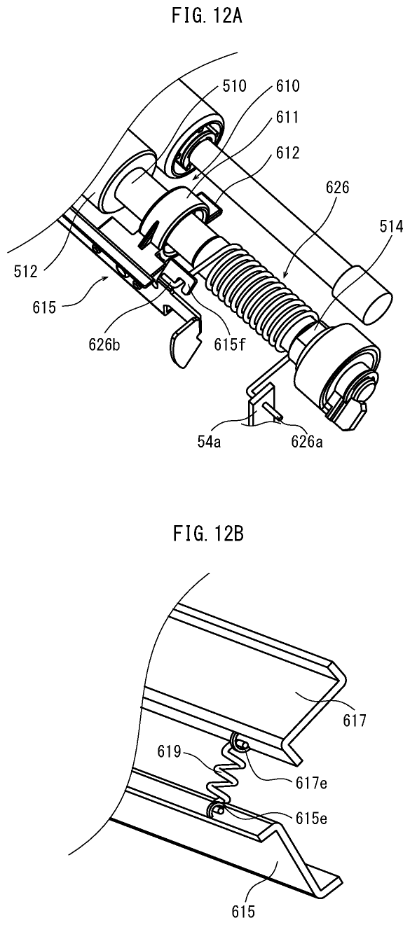

(2) In the above embodiment, the movable gate members 630 and 640 are forced by the torsion spring 618 which is screwed into the rotational shaft 510. Alternatively, the mounting plates 615 and 617 may be coupled to each other via a compression spring such that the movable gate members 630 and 640 are forced via the compression spring. FIG. 12A and FIG. 12B respectively show the structure of a torsion spring and a compression spring 619 relating to the present modification. As shown in FIG. 12A, the mounting plate 615 relating to the present modification is forced by the torsion spring 626, which has a higher number of turns and accordingly a higher restoring force than the torsion spring 616 relating to the above embodiment. Also, instead of providing the torsion spring 618, the compression spring 619 is provided between the mounting plates 615 and 617 as shown in FIG. 12B. Specifically, the compression spring 619 has one end fixed to an axial end 617e of the mounting plate 617 and the other end fixed to an axial end 615e of the mounting plate 615 thereby to couple the mounting plates 615 and 617 to each other.

With the structure shown in FIG. 12A and FIG. 12B, the movable gate members 610 and 620 are forced by an elastic force of the torsion spring 626. Meanwhile, the movable gate members 630 and 640 are forced by an elastic force of the compression spring 619 and the torsion spring 626 which are connected in series. The torsion spring 626 has the greater elastic force than the torsion spring 616. The elastic force of the compression spring 619 acts in a direction opposite to a direction in which the elastic force of the torsion spring 626 acts. Owing to the series-connection of the compression spring 619 and the torsion spring 626, the movable gate members 630 and 640 are forced by the elastic force resulting from subtracting the elastic force of the compression spring 619 from the elastic force of the torsion spring 626. This buffers an impact caused by collision with a sheet, thereby lowering a collision noise.

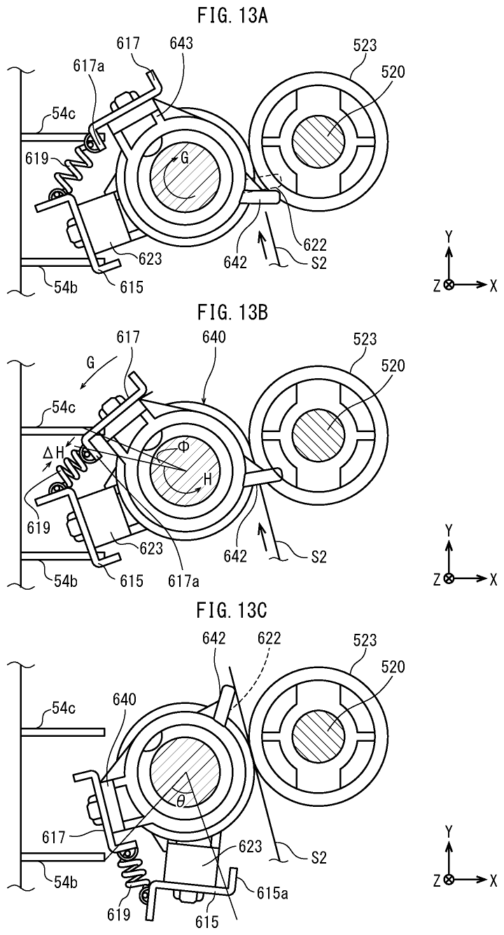

The following describes the operations of the movable gate member 640 relating to the present modification during passing through of a large sheet S2, with reference to FIG. 13A to FIG. 13C. FIG. 13A to FIG. 13C are cross-sectional views of the timing roller pair 34, cut along the line I-I in FIG. 3.

FIG. 13A shows a state where the movable gate member 640 is in the standby mode and the large sheet S2 is about to enter the nip 341. In the standby mode in FIG. 13A, a restoring force of the torsion spring 626 acts on the mounting plate 617 via the compression spring 619 to rotate the movable gate member 640 counterclockwise, namely, in a direction indicated by an arrow G in the figure. Then, the axial end 617a of the mounting plate 617, to which the movable gate members 630 and 640 are mounted, collides with the frame 54c of the side wall of the housing. This maintains the protruding portions 632 and 642 at the second protruding positions 630P shown in FIG. 6.

The movable gate members 630 and 640 are forced by the elastic force, which results from subtracting the elastic force of the compression spring 619 from the elastic force of the torsion spring 626. Accordingly, when the large sheet S2 collides with the protruding portion 642, the compression spring 619 compresses by an amount ΔH as shown in FIG. 13B, and thus the axial end 617a of the mounting plate 617, which is forced by the torsion spring 626, rotates by an angle Φ counterclockwise, namely, in a direction indicated by an arrow H in the figure. A momentum of the large sheet S2 by this collision is converted into a momentum of an energy for compressing the compression spring 619. Thus, the collision of the large sheet S2 with the movable gate member 630 and 640 generates a noise which is not harsh on the ears of a user who is around the printer.

FIG. 13C shows a state where a leading edge Sa of the large sheet S2 being conveyed passes through the nip 341 of the timing roller pair 34. Upon being pressed by the large sheet S2, the axial end 615a of the mounting plate 615 rotates by an angle θ from the position shown in FIG. 13A. Rotation of the mounting plates 615 and 617 causes the protruding portions 612 and 642 of the movable gate members 610, 620, 630, and 640 to retract to the retracted positions 610Q to respectively fit into the through-holes 411a, 411d, 411b, and 411c of the paper feed guide 411 (see FIG. 6).

In the present modification, it is necessary to adjust the strength of the torsion spring 626 and the compression spring 619 in view of their series-connection. In the case where the strength of the compression spring 619 is reduced, the protruding portions 632 and 642, with which a large sheet S2 has collided, causes the compression spring 619 to largely compress. This improves the absorptivity of a kinetic energy of the large sheet S2, but instead decreases the skew correction capability of the protruding portions 632 and 642 which are forced by the compression spring 619. On the contrary, in the case where the strength of the compression spring 619 is increased, the protruding portions 632 and 642, with which a large sheet S2 has collided, presses back the large sheet S2 with an increased force. This improves the skew correction capability of the protruding portions 632 and 642, but instead increases collision noises due to the increased force for pushing back the large sheet S2. Accordingly, the strengths of the torsion spring 626 and the compression spring 619 need to be determined taking into consideration of the relationship with noises resulting from collision of sheets and the skew correction capability of the protruding portions.

(3) In the above embodiment, the movable gate members 630 and 640 are provided in order to correct skew of small sheets S1. However, the present disclosure is not limited to this. A single movable gate member may be provided in order to correct skew of small sheets S1.

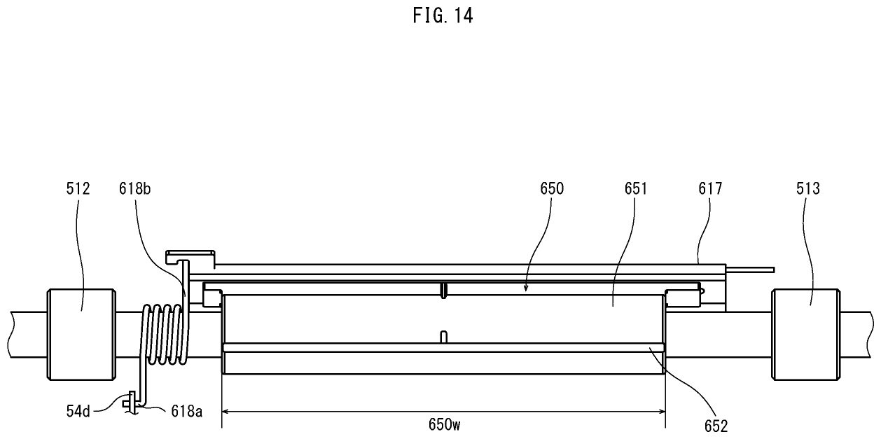

FIG. 14 shows the structure of a conveyance apparatus including only one movable gate member for correcting skew of small sheets S1. The conveyance apparatus shown in the figure includes a movable gate member 650, instead of the roller body 511 and the movable gate members 630 and 640. The movable gate member 650 has the same structure as the movable gate members 610, 620, 630, and 640, excepting the width of protruding portion. Specifically, the movable gate member 650 includes a protruding portion 652 having a width 650W which is equal to the sum of the widths of the roller body 511 and the protruding portions 632 and 642 shown in FIG. 3. With the protruding portion 652 having a large width as above, the movable gate member 650 can correct skew of small sheets S1 and large sheets S2 in the same manner as in the above embodiment.

(4) In the above modification (1), the mounting plate 617s and the torsion spring 618s are provided for the movable gate member 630 to force the movable gate member 630, and the mounting plate 617t and the torsion spring 618t are provided for the movable gate member 640 to force the movable gate member 640. However, the present disclosure is not limited to this. Respective tension springs may be mounted to the movable gate members 630 and 640 to separately force the movable gate members 630 and 640. Specifically, each of the movable gate members 630 and 640 may be forced by fixing one end of a separate tension spring to respective a hook provided in the movable gate member and fixing the other end of the tension spring to the housing. Also, in the above embodiment and modifications (1) and (2), the movable gate members 610, 620, 630, and 640 are forced by the springs. However, the present disclosure is not limited to this. The movable gate members 610, 620, 630, and 640 may be made of metal such that the respective protruding portions switch between the protruding positions and the retracted positions according to the weights of the movable gate members.

(5) In the above embodiment, the movable gate members 630 and 640 are coupled to each other via the mounting plate 617, which is a plate-like member. However, the present disclosure is not limited to this. A member of other shape may be used as a coupling member. For example, a cylindrical member, a rod member, or a wire with a high rigidity may be used for coupling the movable gate members 630 and 640 to each other. The same applies to the movable gate members 610 and 620. Specifically, a cylindrical member, a rod member, or the like may be used as a coupling member for coupling the movable gate members 610 and 620. In the above embodiment, the movable gate members for sheet skew correction include the protruding portions 612, 622, 632, and 642 such as shown in FIG. 4. However, the present disclosure is not limited to this. The movable gate members may include any portions protruding radially from the outer circumferential surfaces of the circular portions and a shape other than the claw shape shown in FIG. 4. For example, the movable gate members may employ a structure such as disclosed in Japanese Unexamined Patent Application Publication No. 2004-26343, in which a semicolumnar shutter covers approximately half of the outer circumferential surface of a timing roller.

(6) Small sheets 51 may include tickets, business cards, bookmarks, and L-size photographs. Also, materials of sheets printable by the printer may include papers and resin. Types of the sheets may include plain paper, high-quality paper, color paper, and coated paper.

(7) In the above embodiment, the conveyance apparatus conveys sheets, which are picked up from the paper cassettes 31a and 31b, to the secondary transfer position. However, the present disclosure is not limited to this. The conveyance apparatus may be applied to automatic document feeders (ADFs) and post-processing apparatuses (finishers) for image forming devices. Also, in the above embodiment, the conveyance apparatus is mounted on the printer. However, the present disclosure is not limited to this. The conveyance apparatus may be applied to multifunction peripherals (MFPs) and single function peripherals (SFPs) such as copiers and facsimiles. The conveyance apparatus also may be applied to production printers and ticket vending machines.

Supplement

The present disclosure aims to provide a conveyance apparatus that includes gate members which include protruding portions with which large sheets collide with a lower noise and corrects skew of small sheets with a higher precision.

The conveyance apparatus relating to at least one embodiment of the present disclosure is a conveyance apparatus that conveys a sheet by passing the sheet through a nip formed between a first conveyance roller and a second conveyance roller contacting each other, the conveyance apparatus includes a first gate member, a second gate member, and a third gate member into which a rotational shaft of the first conveyance roller is loosely inserted, the first and second gate members being disposed at a predefined interval, the third gate member being disposed between the first and second gate members. The first, second, and third gate members each include a portion protruding radially outwards, and the protruding portions are positioned on a conveyance path during no sheet conveyance, the protruding portion of the third gate member being positioned upstream of the protruding portions of the first and second gate members in a conveyance direction. When a first sheet having a width equal to the predefined interval or larger is conveyed, the protruding portions of the first, second, and third gate members push back a leading edge of the first sheet, and then move away from the conveyance path. When a second sheet having a width smaller than the predefined interval is conveyed, only the protruding portion of the third gate member pushes back a leading edge of the second sheet, and then moves away from the conveyance path.

According to at least one embodiment, the third gate member may include a pair of partial gate members that push back areas near both ends of the leading edge of the second sheet being conveyed.

According to at least one embodiment, the first and second gate members may be symmetrical about a line perpendicular to a center of the rotational shaft of the first conveyance roller in an axial direction of the rotational shaft, and the partial gate members of the third gate member may be symmetrical about the line.

The conveyance apparatus according to at least one embodiment may further include: a first coupling member that couples the first and second gate members to each other such that the first and second gate members rotate together; and a second coupling member that couples the partial gate members of the third gate member to each other such that the partial gate members rotate together.

The conveyance apparatus according to at least one embodiment may further include: a first elastic member that applies a force in a direction for causing the protruding portions of the first and second gate members to be positioned on the conveyance path; and a second elastic member that applies a force in a direction for causing the partial gate members of the third gate member to be positioned on the conveyance path.

According to at least one embodiment, the first and second elastic member may be each a coil spring into which the rotational shaft of the first conveyance roller is loosely inserted.

According to at least one embodiment, the force applied by the second elastic member may be lower than the force applied by the first elastic member.

The conveyance apparatus according to at least one embodiment may further include: a first elastic member that applies a force in a first direction for causing the protruding portions of the first and second gate members to be positioned on the conveyance path; and a second elastic member that is disposed between the first and second coupling members, and applies a force in a second direction to the partial gate members of the third gate member, the second direction being opposite to the first direction.

Although one or more embodiments of the present invention have been described and illustrated in detail, the disclosed embodiments are made for the purposes of illustration and example only and not limitation. The scope of the present invention should be interpreted by the terms of the appended claims

What is claimed is:

1. A conveyance apparatus that conveys a sheet by passing the sheet through a nip formed between a first conveyance roller and a second conveyance roller contacting each other, the conveyance apparatus comprising
a first gate member, a second gate member, and a third gate member into which a rotational shaft of the first conveyance roller is loosely inserted, the first and second gate members being disposed at a predefined interval, the third gate member being disposed between the first and second gate members, wherein
the first, second, and third gate members each include a portion protruding radially outwards, and the protruding portions are positioned on a conveyance path during no sheet conveyance, the protruding portion of the third gate member being positioned upstream of the protruding portions of the first and second gate members in a conveyance direction,
when a first sheet having a width equal to the predefined interval or larger is conveyed, the protruding portions of the first, second, and third gate members push back a leading edge of the first sheet, and then move away from the conveyance path, and
when a second sheet having a width smaller than the predefined interval is conveyed, only the protruding portion of the third gate member pushes back a leading edge of the second sheet, and then moves away from the conveyance path.

2. The conveyance apparatus of claim 1, wherein
the third gate member includes a pair of partial gate members that push back areas near both ends of the leading edge of the second sheet being conveyed.

3. The conveyance apparatus of claim 2, wherein
the first and second gate members are symmetrical about a line perpendicular to a center of the rotational shaft of the first conveyance roller in an axial direction of the rotational shaft, and
the partial gate members of the third gate member are symmetrical about the line.

4. The conveyance apparatus of claim 2, further comprises:
a first coupling member that couples the first and second gate members to each other such that the first and second gate members rotate together; and
a second coupling member that couples the partial gate members of the third gate member to each other such that the partial gate members rotate together.

5. The conveyance apparatus of claim 2, further comprising:
a first elastic member that applies a force in a direction for causing the protruding portions of the first and second gate members to be positioned on the conveyance path; and
a second elastic member that applies a force in a direction for causing the partial gate members of the third gate member to be positioned on the conveyance path.

6. The conveyance apparatus of claim 2, wherein
the first and second elastic member are each a coil spring into which the rotational shaft of the first conveyance roller is loosely inserted.

7. The conveyance apparatus of claim 5, wherein
the force applied by the second elastic member is lower than the force applied by the first elastic member.

8. The conveyance apparatus of claim 2, further comprising:
a first elastic member that applies a force in a first direction for causing the protruding portions of the first and second gate members to be positioned on the conveyance path; and
a second elastic member that is disposed between the first and second coupling members, and applies a force in a second direction to the partial gate members of the third gate member, the second direction being opposite to the first direction.
